(19) United States
(12) Patent Application Publication
(10) Pub. No.: US 2022/0089038 A1
(43) Pub. Date: Mar. 24, 2022

(54) Energy Storage Cell, Battery Module, and Production Method

(71) Applicant: Bayerische Motoren Werke Aktiengesellschaft, Muenchen (DE)

(72) Inventors: Franz FUCHS, Muenchen (DE); Kevin GALLAGHER, Dachau (DE); Frederik MORGENSTERN, Muenchen (DE); Seokyoon YOO, Baldham (DE)

(21) Appl. No.: 17/420,228

(22) PCT Filed: Jan. 24, 2020
(86) PCT No.: PCT/EP2020/051769

§ 371 Date: Jul. 1, 2021

(30) Foreign Application Priority Data
Jan. 28, 2019 (DE) 10 2019 102 032.8

(51) Int. Cl. B60L 50/64; H01M 10/0585; H01M 50/103; H01M 50/172

(52) U.S. Cl. CPC B60L 50/64; H01M 50/172; H01M 50/103; H01M 10/0585

(57) ABSTRACT

An electrochemical energy storage cell includes multiple electrodes of a first polarity and multiple electrodes of a second polarity that are arranged in an electrode stack. Each of the electrodes of the first polarity has a first arrester lug which protrudes out of the electrode stack on a first side of the electrode stack, and each of the electrodes of the second polarity has a second arrester lug which protrudes out of the electrode stack on a second side of the electrode stack. The electrode stack is arranged in a housing which is connected to the first arrester lug in an electrically conductive manner. A connection element which is arranged in a housing wall of the housing and is electrically connected to the second arrester lug is electrically insulated from the housing and is configured to electrically connect the exterior of the housing and the second arrester lug.

### BACKGROUND AND SUMMARY OF THE INVENTION

The present invention relates to an electrochemical energy storage cell, in particular for a vehicle, to an energy storage module consisting of multiple such energy storage cells, to a vehicle comprising such an energy storage module, and to a method for producing an energy storage cell.

In order to facilitate adequate ranges for vehicles that are at least partially driven by electric motors, large-volume energy stores with a large number of energy storage cells are usually installed due to the lower energy density of energy storage cells, for example lithium-ion cells, in comparison with fuels such as gasoline or diesel. In the light of the space available in such vehicles, this presents a challenge, especially since the high weight associated with the large-volume implementation of the energy stores must also be taken into consideration.

For this reason, what are known as prismatic energy storage cells are usually arranged in the floor of the vehicle, i.e. underneath the passenger compartment. The cell height, i.e. the dimension of the installed cell in the vertical direction, is here generally determined by the desired vehicle height, so that the cells of low vehicles, such as sports cars for example, have a flatter implementation than those of higher vehicles such as, for example, transporters or SUVs. In almost all cases, the installed cells have, however, a greater cell width, i.e. the dimension in the horizontal direction along the width of the vehicle, than the cell height. The cell thickness, i.e. the dimension in the horizontal direction along the vehicle's longitudinal axis, is here usually determined by the cooling capability and the safety properties of the individual cells.

It is an object of the present invention to improve electrochemical energy storage cells, in particular in respect of the space requirement in vehicles. It is in particular an object of the present invention to specify an electrochemical energy storage cell that can be contacted in a particularly space-saving manner.

This object is achieved through an electrochemical energy storage cell, in particular for a vehicle, a battery module with such electrochemical energy storage cells, a vehicle with such an energy storage module and a method for producing an electrochemical energy storage cell according to the claimed invention.

A first aspect of the invention relates to an electrochemical energy storage cell, in particular for a vehicle, comprising: (i) an electrode stack that contains multiple electrodes of a first polarity and multiple electrodes of a second polarity opposite the first polarity, wherein the electrodes of the first polarity each comprise a first conductor lug that protrudes out of the electrode stack on a first side of the electrode stack, and the electrodes of the second polarity each comprise a second conductor lug that protrudes out of the electrode stack on a second side of the electrode stack opposite the first side; (ii) a housing in which the electrode stack is arranged and that is connected electrically conductively to the first conductor lugs; and (iii) a connecting element arranged in a housing wall of the housing and electrically connected to the second conductor lugs, that is electrically insulated from the housing and is configured to electrically connect an outer side of the housing and the second conductor lugs.

The invention is based in particular on the approach of placing the housing of an energy storage cell at the potential of electrodes of the energy storage cell that have a first polarity, for example positive. To this end, the electrodes of the first polarity, for example positive electrodes, and electrodes of a second polarity opposite the first, for example negative electrodes, are designed and/or arranged in such a way that first conductor lugs of the electrodes of the first polarity and second conductor lugs of the electrodes of the second polarity each lie on sides of an electrode stack that are opposite one another, so that the first conductor lugs can particularly easily be electrically connected to the housing. In particular, the first conductor lugs can lie essentially directly against a housing wall of the housing. The electrode stack can therefore occupy a higher proportion of the housing volume than with conventional cell designs. Components can furthermore be saved, and an improved heat dissipation from the electrode stack to the housing facilitated. For example, components that electrically connect the first conductor lugs and an outer side of the housing can be omitted, so that space is saved. As a result, the energy density of the energy storage cell can also be increased in comparison with conventional cells.

The energy storage cell can preferably thus be integrated via the housing into an electrical circuit, wherein the housing forms one pole of the first polarity. One pole of the second polarity is thus preferably formed from a connecting element that is arranged in a housing wall of the housing and is electrically connected to the second conductor lugs. To this end, the connecting element can, for example, be recessed into the housing wall. It is also conceivable that the connecting element is formed by a part of the housing or of the housing wall. The connecting element can, in particular, be a section of the housing wall that is electrically insulated from the rest of the housing or part of the housing wall. The arrangement or design of the first and second conductor lugs on mutually opposite sides of the electrode stack here facilitates particularly reliable electrical insulation of the connecting element. Embodiments in which the conductor lugs lie on opposite sides lead to a more homogeneous current distribution within the stack, which has a positive effect on the performance and the service life. The connecting element can also in this case be made larger in order to be able to carry higher currents reliably, for example without significantly heating up, since additional space for a further connecting element corresponding to the first polarity is not needed at the housing wall.

Because the housing of the energy storage cell is at the potential of the electrodes of the first polarity, further components can also be saved when connecting the energy storage cell into an electrical circuit, whereby costs as well as space are saved. The direct contact between the first conductor lugs and the housing also facilitates an improved thermal connection of the electrode stack, in particular the electrodes of the first polarity, and thus provides improved cooling properties for the energy storage cell.

The new cell design thus allows for a high energy density with a safety that remains at least the same and a reduction in the number of mechanical components. The new cell design furthermore facilitates new variants for contacting the cells to one another.

Altogether, embodiments of the invention facilitate improved energy storage cells, particularly in respect of their space requirement in vehicles.

Preferred embodiments of the invention and their developments are described below, each of which, unless this is explicitly excluded, can be combined in any desired way with one another as well as with the aspects of the invention described further below.

In one preferred embodiment, the housing is designed as a prismatic housing having two transverse sides lying opposite one another, each having a first surface area, two longitudinal sides lying opposite one another, each having a second surface area, and two primary sides lying opposite one another, each having a third surface area, and wherein the connecting element is arranged in one of the transverse sides, and the first surface area is smaller than both the second and the third surface areas. The second conductor lugs here preferably contact the housing on the other of the two transverse sides. As a result, the volume in the housing can be used more efficiently since, for example, a gap between the electrode stack and the housing, in which the conductor lugs for electrical connection to the housing or to the connecting element are arranged, takes up less space on one of the transverse sides than on one of the longitudinal sides or even primary sides.

In a further preferred embodiment, the electrochemical energy storage cell further comprises at least one strain relief element that is arranged on one of the longitudinal sides and is designed to reduce a gas pressure in the interior of the housing. The at least one strain relief element is here preferably implemented as a bursting membrane and is fabricated, for example, through mechanical stamping of one of the longitudinal sides and/or laser ablation. The strain relief element can here extend, at least partially, but preferably essentially completely, along one of the longitudinal sides. In this way a gas developed in the interior of the housing, for example as a result of a malfunction of the energy storage cell, can be released safely and reliably, in particular in a controlled manner, on one of the longitudinal sides of the housing; this preferably occurs if the gas pressure in the interior of the housing reaches or exceeds a predefined threshold value of the pressure.

The housing of the electrochemical energy storage cell can, for example, be arranged in the floor of a passenger compartment of a vehicle, i.e. underneath the passenger compartment. Preferably here the longitudinal sides of the housing extend essentially parallel to the floor of the passenger compartment, whereby the space underneath the passenger compartment can be utilized particularly efficiently. Preferably the at least one strain relief element is located on a longitudinal side of the housing facing away from the floor of the passenger compartment, so that, if gas emerges from the interior of the housing through the at least one strain relief element, persons who are in the passenger compartment are not endangered. In a further embodiment, the at least one strain relief element comprises one, two or more outlet openings that are arranged on one or both of the sides of the housing lying opposite the conductor lugs.

In a further preferred embodiment, the housing comprises a gas duct that opens at the strain relief element. As a result, gas arising in the interior of the housing, perhaps due to a malfunction of the energy storage cell, can be discharged particularly reliably via the strain relief element.

In a further preferred embodiment, the housing is composed of at least a first housing part that is electrically connected to the first conductor lugs, and a second housing part in which the connecting element is arranged. As a result, the electrical connections between the first conductor lugs and the housing or between the second conductor lugs and the connecting element can be implemented in a particularly robust manner, since, during the production of the energy storage cell, each of the electrical connections can thus be fabricated separately and therefore with particular care and precision.

A second aspect of the invention relates to an energy storage module that comprises at least two energy storage cells according to the first aspect of the invention.

In a preferred embodiment, the at least two energy storage cells are arranged in two cell stacks lying opposite one another, wherein the energy storage cells in the two cell stacks are here preferably oriented in such a way that the connecting elements, in particular the transverse sides, of two energy storage cells in each case are located opposite one another. As a result, the energy storage cells in the two cell stacks can be connected to one another in a particularly simple manner, for example by way of contact electronics extending between the cell stacks, and for example integrated into an electrical circuit.

A third aspect of the invention relates to a vehicle, in particular a motor vehicle, with an energy storage module according to the second aspect of the invention.

A fourth aspect of the invention relates to a method for producing an energy storage cell, in particular according to the first aspect of the invention, comprising the following working steps: (i) arranging multiple electrodes of a first polarity and multiple electrodes of a second polarity that is opposite the first polarity in an electrode stack in such a manner that first conductor lugs of the electrodes of the first polarity each protrude out of the electrode stack on a first side of the electrode stack, and second conductor lugs of the electrodes of the second polarity each protrude out of the electrode stack on a second side of the electrode stack lying opposite the first; (ii) establishing a first electrical connection between the first conductor lugs and a housing; (iii) establishing a second electrical connection between the second conductor lugs and a connecting element arranged in a housing wall of the housing that is electrically insulated from the housing and is configured to electrically connect an outer side of the housing and the second conductor lugs; and sealing the housing.

The housing can here be composed of multiple housing parts, in particular a first housing part and a second housing part. In addition, the housing can also be composed of a third housing part, and in appropriate cases also further housing parts. The housing parts here, in particular the first and second housing parts, are joined together prior to the sealing, preferably to form the housing. Due to the sealing, for example by way of laser welding, a stable mechanical connection can then be established between the housing parts.

In a preferred embodiment, the electrical connection is established between the first conductor lugs and a second housing part. The second electrical connection is preferably established between the second conductor lugs and a connecting element that is arranged in a housing wall of a second housing part that is provided separately from the first housing part. The first housing part and the second housing part are preferably joined together. The production process can be significantly simplified thereby.

The housing parts are preferably joined together before establishing one or both electrical connections between the first conductor lugs and the housing or between the second conductor lugs and the connecting element. It can be ensured in this way that the first and/or second conductor lugs are arranged precisely relative to the housing or to the connecting element, in particular aligned, before one or both of the electrical connections is or are established.

Alternatively, the housing parts can also be joined together after establishing one or both electrical connections between the first conductor lugs and the housing or between the second conductor lugs and the connecting element. The conductor lugs can thereby be electrically connected particularly reliably and carefully to the housing or to the connecting element.

The first housing part can, for example, be designed as a prismatic housing that is opened on one of its primary sides. The electrode stack can be inserted through the opened primary side. The first conductor lugs here preferably come into contact with the housing and the second conductor lugs with the connecting element and can be permanently connected electrically conductively to the housing or to the connecting element for example by way of laser welding, ultrasonic welding or spot welding with a high current. After the electrical connections have been established in this way, the opened primary side can be closed with a second housing part serving as a cover.

In a further preferred embodiment, the first and second housing parts are joined together after establishing the electrical connections, in that at least the first housing part, or the second housing part, is tilted relative to the electrode stack, in particular through essentially 90°. In particular both the first and the second housing part can be tilted. The electrical connections between the first conductor lugs and the housing or the second conductor lugs and the connecting element preferably form tilt axes about which the first and/or second housing part is/are tilted relative to the electrode stack. In this way, a particularly large amount of space is available when producing the energy storage cell in order to establish at least one of the electrical connections, for example by way of laser welding.

It is, for example, conceivable that the electrode stack is arranged between the first and second housing parts in such a way that a housing wall, through which the first conductor lugs are to be connected electrically conductively to the housing, and the connecting element are each aligned perpendicularly to the electrode stack. After establishing the electrical connections, the first and second housing parts can then be tilted, for example in the same direction, i.e. clockwise or anticlockwise, in order to close the housing.

In a further preferred embodiment, the first and second housing parts are joined together in that at least the first housing part and the electrode stack, or the second housing part and the electrode stack, are moved together relative to a third housing part, in particular inserted into the third housing part. In particular, the first housing part, second housing part and electrode stack can be moved together, perhaps along an assembly direction. This facilitates a precise alignment of the three housing parts relative to one another.

For example, the first conductor lugs can be electrically connected to the first housing part which, after assembly, forms one of the two transverse sides of the housing, and the second conductor lugs can be electrically connected to the connecting element arranged in the second housing part which, after assembly, forms the other of the two transverse sides of the housing. The combination of the first housing part, electrode stack and second housing part can then, like a drawer, be inserted into the third housing part which, after assembly, forms the two longitudinal sides and the two primary sides of the housing.

In order to ease the process of inserting the combination, the third housing part can here also comprise a stop, for example an offset or stepped region, against which, for example, the first housing part or the second housing part comes to rest. In this way, particularly precise alignment of the three housing parts relative to one another can be achieved.

In a further preferred embodiment, the first conductor lugs are pressed at least in sections by a holding element against the first housing part when establishing the electrical connection to the first housing part. The holding element is preferably designed here to fill a gap between the electrode stack and the first housing part, in particular a housing wall of the first housing part which, after assembly of the housing, forms one of the two transverse sides, or to be inserted into this gap. In this way, it can be ensured that the first conductor lugs lie flat against the first housing part when establishing the electrical connection.

By pressing the first conductor lugs against the first housing part, the first conductor lugs can be welded to the first housing part from a housing side lying opposite. In particular in this way, first conductor lugs that are pressed against the first housing part in the interior of the assembled housing can be electrically connected to the housing from outside the housing, in particular through laser welding, perhaps in that the housing, on an outer housing side, perhaps one of the two transverse sides behind which the first conductor lugs are pressed against the housing, is heated at least in sections, so that the first conductor lugs connect to the corresponding inner side of the housing.

In a further preferred embodiment, the electrical connection of the first conductor lugs to the first housing part and/or the electrical connection of the second conductor lugs to the second housing part and/or the assembled housing is/are established or sealed by laser welding. A high connecting speed or sealing speed can be achieved in this way.

In addition, laser welding is advantageous in respect of the achievable energy density of the produced energy storage cell, since in this way thin, narrow welding seams that require little space in the housing are generated.

In a further preferred embodiment, the preferably rod-shaped holding element is introduced at least partially through a filling opening or a strain relief element, in particular an outlet opening, of the already assembled housing into the interior of the already assembled housing, in particular in such a way that first conductor lugs pressed against the first housing part can be electrically connected to the housing from outside the housing, in particular through laser welding. The holding element can subsequently be removed once more from the housing through the filling opening or the strain relief element. This makes it possible to utilize the space in the interior of the housing particularly efficiently.

The features and advantages described with reference to the first aspect of the invention and its advantageous embodiment also apply, at least where technically appropriate, to the second, third and fourth aspects of the invention and their advantageous embodiment, and vice versa.

Further features, advantages and potential applications of the invention emerge from the following description in connection with the figures, in which the same reference signs are consistently used for the same or mutually corresponding elements of the invention.

### BRIEF DESCRIPTION OF THE DRAWINGS

FIG. 1 shows an exemplary embodiment of an energy storage cell according to the invention.

FIGS. 2A and 2B show a first example of assembly states of the electrochemical energy storage cell of FIG. 1.

FIG. 3 shows a second example of an assembly state of the electrochemical energy storage cell of FIG. 1.

FIG. 4 shows a third example of an assembly state of the electrochemical energy storage cell of FIG. 1.

FIG. 5 shows a fourth example of an assembly state of the electrochemical energy storage cell of FIG. 1.

FIG. 6 shows a preferred exemplary embodiment of an energy storage module according to the invention.

FIG. 7 shows a preferred exemplary embodiment of a method according to the invention.

### DETAILED DESCRIPTION OF THE DRAWINGS

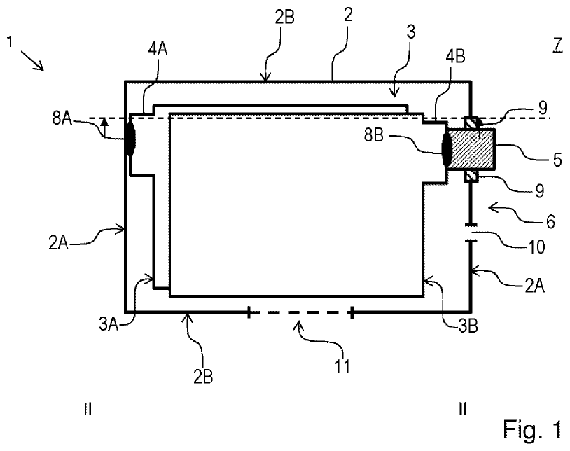

FIG. 1 shows an exemplary embodiment of an energy storage cell 1 according to the invention that comprises a housing 2 and an electrode stack 3 arranged therein, viewed from the side. The electrode stack 3 contains electrodes of a first polarity, each of which comprises a first conductor lug 4a protruding out of the electrode stack 3 on a first side 3a of the electrode stack 3, and electrodes of a second polarity opposite the first, each of which comprises a second conductor lug 4b protruding out of the electrode stack 3 on a second side 3b of the electrode stack 3. The electrodes of different polarity are preferably here each separated electrically from one another by a separator. The electrodes of the first polarity can, for example, be positive electrodes, and the electrodes of the second polarity can be negative electrodes, which, as shown by way of example in FIG. 1 for one pair, are each arranged adjacently in the electrode stack 3.

There is a first electrically conductive connection 8a between the first conductor lugs 4a and the housing 2, which preferably will be or is established by a materially bonded connecting method such as soldering or welding, in particular ultrasonic or laser welding. The housing 2 is thereby placed at the electrical potential of the electrodes of the first polarity, and preferably acts accordingly as one electrical pole of the energy storage cell 1.

A second electrical pole of the energy storage cell 1 is preferably formed by a connecting element 5 that is arranged in a housing wall 6 of the housing 2. The connecting element 5 can here be connected to the second conductor lugs 4b, for example by way of a second electrically conductive connection 8b that preferably will be or is established in a manner analogous to the first electrically conductive connection 8a. The connecting element 5 can here, for example, be routed through the housing wall 6, so that an outer side 7 of the housing 2 and the second conductor lugs 4b, in particular the electrodes of the second polarity, are or will be electrically connected. The connecting element 5 is preferably electrically insulated and sealed off from the housing 2, for example recessed into an electrically insulating material 9, so that an electrolyte-proof electrically conductive connection is formed.

In this way, the electrochemical energy storage cell 1 can be electrically contacted both at the housing 2 and at the connecting element 5, and integrated into an electric circuit. Due to the possibility of being able to contact the housing 2 at almost any arbitrary point to connect to the electrodes of the first polarity, the cable routing is simplified, as a consequence of which the space requirement, for example in a vehicle, is advantageously reduced.

The conductor lugs 4a, 4b are preferably designed flexibly. The conductor lugs 4a, 4b can, for example, be formed of collector foils of the electrodes. As a result, the conductor lugs 4a, 4b can easily be curved or bent, in particular folded, and thereby positioned or aligned for connection to the housing 2 or to the connecting element 5.

The energy storage cell 1 shown in FIG. 1 is preferably a cell with a prismatic housing 2 that comprises two primary sides lying opposite one another (lying parallel to the plane of the drawing), two longitudinal sides 2b lying opposite one another, and two transverse sides 2a lying opposite one another. The housing wall 6 in which the connecting element 5 is arranged here preferably forms one of the transverse sides 2a.

In the example shown, a filling opening 10 is also arranged in the housing wall 6, i.e. on one of the two transverse sides 2a, and is designed to fill the housing 2 from the outer side 7 with an electrolyte. The filling opening 10 can, for example, comprise a valve or be designed as such a valve.

In the example shown, a strain relief element 11 is arranged on one of the longitudinal sides 2b, and is designed to reduce a gas pressure in the interior of the housing. The strain relief element 11 can perhaps be designed as a valve or can comprise such a valve. The strain relief element is preferably formed by a section of one of the longitudinal sides 2b, which facilitates a release of gas from the housing 2 if a gas pressure threshold value is exceeded. The strain relief element can, for example, be designed as a predetermined breaking point.

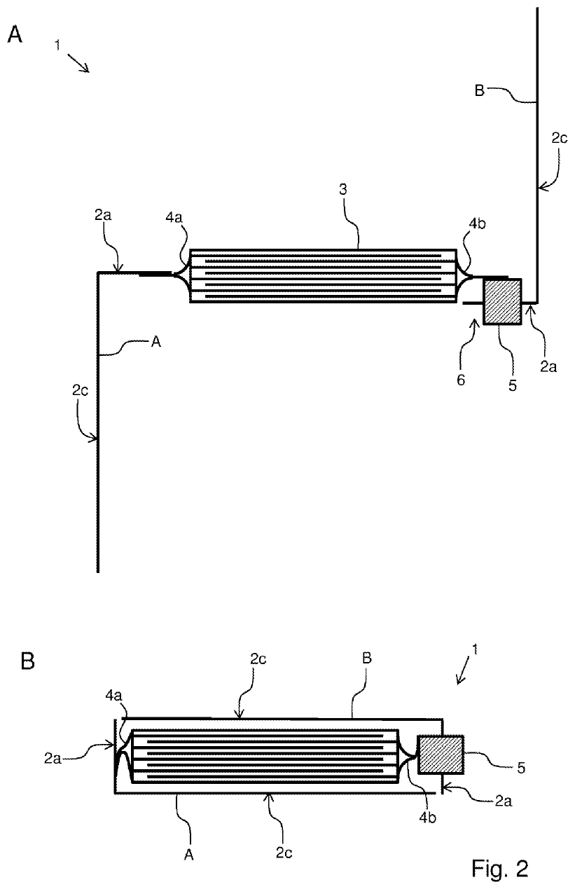

FIGS. 2A and 2B show a first example of assembly states of the electrochemical energy storage cell 1 of FIG. 1, which is illustrated in the cross section II drawn in FIG. 1. In FIG. 2A, the first conductor lugs 4a have already been electrically conductively connected to the first housing part A (e.g. by laser welding or ultrasonic welding). The second conductor lugs 4b are also already electrically conductively connected to the connecting element 5, while the connecting element 5 is arranged in a housing wall 6 of the second housing part B separate from the first housing part A.

The first conductor lugs 4a are here preferably electrically conductively connected to one of the transverse sides 2a, while the connecting element 5 is preferably arranged in the other of the transverse sides 2a. The electrically conductive connections 8a, 8b between the first or second conductor lugs 4a, 4b and the first housing part A or the connecting element 5 here in a preferred manner form axes of rotation (perpendicular to the plane of the drawing) about which the first housing part A and the second housing part B are tilted relative to the electrode stack 3.

To assemble the housing, the first housing part A and the second housing part B can subsequently be tilted relative to the electrode stack 3, in particular through 90° in each case, so that, for example, the two primary sides 2c lie opposite one another.

FIG. 2B shows the electrochemical energy storage cell 1 after “folding together” the two housing parts A, B, so that the electrode stack 3 with the protruding first conductor lugs 4a of the electrodes of the first polarity and the protruding second conductor lugs 4b of the electrodes of the second polarity is arranged inside the housing, and is thus already electrically conductively connected to a first housing part A. The primary sides 2c here extend essentially parallel to the electrodes in the electrode stack.

The first housing part A and the second housing part B can subsequently be connected to one another, for example welded to one another, for example by way of laser welding, in order to seal the housing.

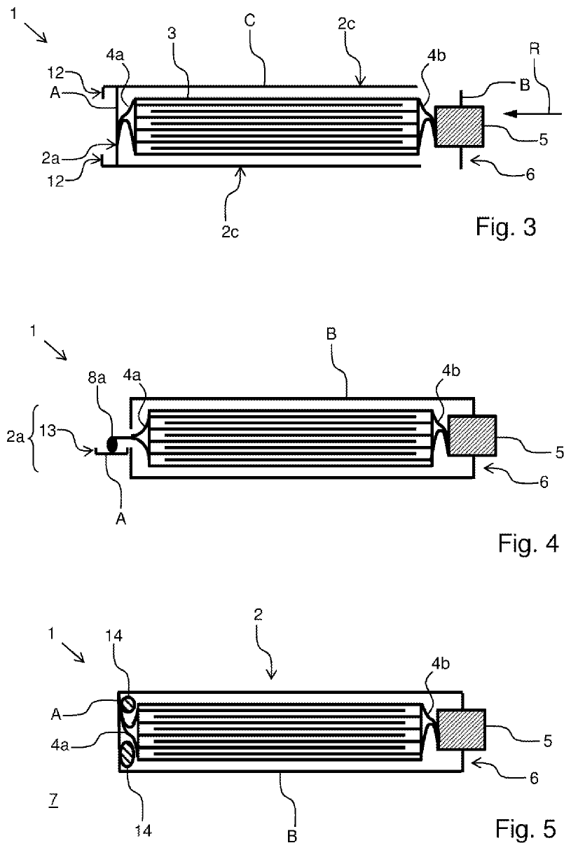

FIG. 3 shows a second example of an assembly state of the electrochemical energy storage cell 1 of FIG. 1, which is illustrated in the cross section II drawn in FIG. 1. The first conductor lugs 4a have already, in an earlier process step, been electrically conductively connected to the first housing part A (e.g. by laser welding or ultrasonic welding). The second conductor lugs 4b, similarly to the first conductor lugs 4a, have also already, in an earlier process step, been electrically conductively connected to the connecting element 5 that is arranged in a housing wall 6 of the second housing part B that is separate from the first housing part A.

The first housing part A, which is preferably formed of one of the transverse sides 2a, and at least a part of the electrode stack 3, are inserted into a third housing part C. The third housing part C here preferably comprises the two primary sides 2c that lie opposite one another, and the two longitudinal sides that lie opposite one another (extending parallel to the plane of the drawing).

The housing can be assembled in that the first housing part A and the second housing part B, together with the electrode stack 3, are moved further relative to the third housing part C, for example in an insertion direction R, or that the electrode stack 3 is inserted further into the third housing part C. The third housing part C here preferably comprises a stop 12 against which the first and second housing parts A, B and the electrode stack 3 can be aligned. The third housing part C can for example be welded precisely to the first housing part A and the second housing part B if the first housing part A abuts the stop 12.

In an alternative implementation, the housing part C does not comprise a stop 12, in particular if the three housing parts A, B, C are manufactured so precisely that the first and/or the second housing part A, B has/have no or only very little play in the third housing part C. In this case, the stop 12 can also be omitted for reliably welding the three housing parts A, B, C.

FIG. 4 shows a third example of an assembly state of the electrochemical energy storage cell 1 of FIG. 1, which is illustrated in the cross section II drawn in FIG. 1. The second conductor lugs 4b have already been electrically conductively connected to the connecting element 5 that is arranged in a housing wall 6 of the second housing part B that is separate from the first housing part A.

The first conductor lugs 4a here preferably protrude out of the second housing part B, in particular on a side of the second housing part B that lies opposite the housing wall 6 in which the connecting element 5 is arranged. The first conductor lugs 4a can, to this end, for example, be inserted through a cut-out in the second housing part B, in particular in such a way that the first electrically conductive connection 8a between the first conductor lugs 4a and the first housing part A can be established outside the second housing part B. The second housing part B can for example comprise a housing wall, in particular in the region of the first conductor lugs 4a, which forms at least a section of one of the two transverse sides 2a. This housing wall preferably comprises the cut-out through which the first conductor lugs 4a protrude out of the second housing part B.

The first housing part A, which is preferably formed of at least one further section of one of the two transverse sides 2a, is here, in the example shown, tilted with respect to the electrode stack 3 or to the second housing part B. To assemble the housing, the first housing part A, after it has been connected, e.g. welded, to the first conductor lugs 4a, can therefore be subsequently tilted relative to the electrode stack 3 or to the second housing part B, in particular through 90°, and welded to the second housing part B. Preferably the first conductor lugs 4a are designed flexibly, so that they are folded into the assembled housing when the first housing part A is tilted.

The first housing part A can here comprise a housing edge 13 that is configured to contact the second housing part B. As a result, the first housing part A forms a step that offers additional space for the second conductor lugs 4b on the transverse side 2a that lies opposite the housing wall 6 in which the connecting element 5 is arranged. Alternatively, the first housing part A can also however be designed without the housing edge 13, so that the transverse side 2a that lies opposite the housing wall 6, in which the connecting element 5 is arranged, is of essentially planar design.

FIG. 5 shows a fourth example of an assembly state of the electrochemical energy storage cell 1 of FIG. 1, which is illustrated in the cross section II drawn in FIG. 1. The housing 2 has already been assembled here, and the second conductor lugs 4b have already been electrically conductively connected to the connecting element 5 that is arranged in a housing wall 6 of the second housing part B that is separate from the first housing part A.

The first conductor lugs 4a are, on the other hand, preferably not yet connected to the housing 2, but rather are pressed by at least one holding element 14 at least in sections against the housing 2, in particular against the first housing part A. The at least one holding element 14 thus positions the first conductor lugs 4a to establish the electrically conductive connection between the first conductor lugs 4a and the housing 2, in particular the first housing part A.

The electrically conductive connection between the first conductor lugs 4a and the housing 2 can, for example, be established in that a laser beam is aimed from an outer side 7 of the housing 2 onto that housing wall behind which the first conductor lugs 4a are pressed against the housing wall by the at least one holding element 14. The local heating of the housing wall caused by the laser beam causes the housing wall to be welded to the first conductor lugs 4a arranged behind it.

Alternatively, the first conductor lugs 4a can also be welded to the housing 2 by way of a laser beam in that the laser beam is guided through an opening into the interior of the already assembled housing 2. The laser beam can here, for example, be guided into the interior of the already assembled housing 2 through the filling opening shown in FIG. 1 or the strain relief element shown in FIG. 1. Alternatively, a rod-shaped sample can also be inserted through the strain relief element or the filling opening, by way of which the conductor lugs can be fixed at least in sections and/or temporarily, so that they can be welded from the outside, for example by way of a laser. In a further embodiment, the rod-shaped sample comprises a heating element, for example like a soldering iron, at the tip, by way of which the conductor lugs can be directly welded to the housing wall in the interior of the housing 2.

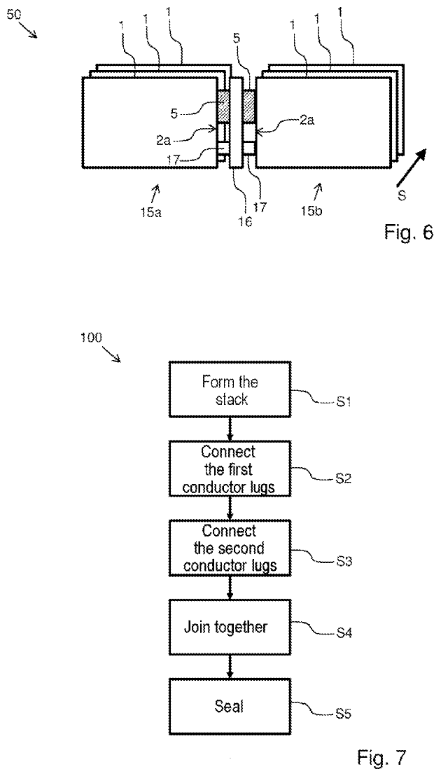

FIG. 6 shows a preferred exemplary embodiment of an energy storage module 50 according to the invention that comprises multiple electrochemical energy storage cells 1. The energy storage cells 1 are, in particular in pairs, stacked along a stacking direction S and form two adjacently arranged cell stacks 15a, 15b. Preferably two energy storage cells 1 in each case thus respectively form one layer of the module 50.

The energy storage cells 1 can be integrated into an electrical circuit, for example into an on-board electrical system of a vehicle, by way of contact electronics 16 that preferably connect the energy storage cells 1 to one another. The contact electronics 16 are here preferably configured to contact electrically the connecting elements 5 of the energy storage cells 1 and the housing of the energy storage cell 1. For reasons of clarity, only the connecting elements 5 and the housing contacts 17 in a first layer of the cell stack 15a, 15b are shown in FIG. 7. To save space, the energy storage cells 1 are contacted here at one of their (short) transverse sides 2a.

Alternatively to the arrangement shown in FIG. 7 in which the contact electronics 16 are in each case arranged between two energy storage cells 1 in one layer of the energy storage module 50, the contact electronics 16 can also be arranged on two sides of the energy storage module 50 that lie opposite one another in such a way that the energy storage cells 1 lie, preferably in pairs, between the contact electronics 16. In other words, in this case, the connecting elements 5 and the housing contacts 17 are located on the outer transverse sides of the energy storage cells 1.

FIG. 7 shows a preferred exemplary embodiment of a method 100 according to the invention for producing an energy storage cell.

In a method step S1, multiple electrodes of a first polarity and multiple electrodes of a second polarity opposite the first polarity are arranged in an electrode stack. An electrode of the first polarity and an electrode of the second polarity are here stacked over one another, preferably in alternation, for example along a stacking direction. A separator, for example a porous polymer membrane, is preferably arranged between each electrode pair of the first and second polarity, electrically insulating the electrodes from one another but, however, allowing lithium ions to pass, for example through pores in the polymer membrane.

The electrodes of the first and second polarity here each comprise conductor lugs. In the course of stacking, the electrodes are preferably arranged in such a way that first conductor lugs of the electrodes of the first polarity protrude out of the electrode stack on a first side of the formed electrode stack, and second conductor lugs of the electrodes of the second polarity protrude out of the electrode stack on a second side of the electrode stack lying opposite the first side.

In a further method step S2, an electrical connection is preferably established between the first conductor lugs and a first housing part, and, in a further method step S3, an electrical connection is preferably established between the second conductor lugs and a connecting element that is arranged in a housing wall of a second housing part. The electrical connection can, for example, be established through a materially bonded connection of the first and second conductor lugs to the first housing part or the connecting element respectively, perhaps through ultrasonic welding or, preferably, through laser welding.

In a further method step S4, the first housing part and the second housing part are connected to one another, for example in that the first and second housing parts are joined together by tilting relative to the electrode stack. In a further method step S5, the housing that has been assembled in this way can be sealed. The sealing is also preferably achieved through a materially bonded connection between the housing parts, in particular through welding the housing parts using a laser beam.

Other implementations of the method 100 are also conceivable as an alternative to the method flow shown in FIG. 8. The housing can, for example, be at least partially assembled from the first and second housing parts before the electrical connections are established in method steps S2, S3. It is also possible first to connect the first conductor lugs to the first housing part and then to assemble the housing at least partially before the second conductor lugs are then connected to the connecting element, or vice versa.

### LIST OF REFERENCE SIGNS

1 Electrochemical energy storage cell
2 Housing
2a, 2b, 2c Transverse side, longitudinal side, primary side
3 Electrode stack
3a, 3b, 3c First, second, third side
4a, 4b First, second conductor lugs
5 Connecting element
6 Housing wall
7 Outer side
8a, 8b First, second electrically conductive connection
9 Insulating material
10 Filling opening
11 Strain relief element
12 Stop
13 Housing edge
14 Holding element
15a, 15b Cell stack
16 Contact electronics
17 Housing contact
50 Energy storage module
100 Method
S1-S5 Method steps
A, B, C First, second, third housing part
S Stacking direction
R Insertion direction

1.-15. (canceled)

16. An electrochemical energy storage cell, comprising:
an electrode stack comprising a plurality of electrodes of a first polarity and a plurality of electrodes of a second polarity opposite the first polarity, wherein each of the electrodes of the first polarity comprises a first conductor lug which protrudes out of the electrode stack on a first side of the electrode stack, and each of the electrodes of the second polarity comprises a second conductor lug which protrudes out of the electrode stack on a second side of the electrode stack opposite the first side;
a housing in which the electrode stack is arranged and that is connected electrically conductively to the first conductor lugs; and
a connecting element which is arranged in a housing wall of the housing and is electrically connected to the second conductor lugs, wherein the connecting element is electrically insulated from the housing and is configured to electrically connect an outer side of the housing and the second conductor lugs.

17. The energy storage cell according to claim 16, wherein
the housing is configured as a prismatic housing having two transverse sides lying opposite one another, each of the transverse sides having a first surface area, two longitudinal sides lying opposite one another, each of the longitudinal sides having a second surface area, and two primary sides lying opposite one another, each of the primary sides having a third surface area,
the connecting element is arranged in one of the transverse sides, and
the first surface area is smaller than both the second surface area and the third surface area.

18. The energy storage cell according to claim 17, further comprising at least one strain relief element that is arranged on one of the longitudinal sides and is configured to reduce a gas pressure in an interior of the housing.

19. The energy storage cell according to claim 18, wherein the housing comprises a gas duct that opens at the at least one strain relief element.

20. The energy storage cell according to claim 16, wherein the housing comprises a first housing part that is electrically connected to the first conductor lugs, and a second housing part in which the connecting element is arranged.

21. An energy storage module comprising at least two energy storage cells according to claim 16.

22. The energy storage module according to claim 21, wherein the at least two energy storage cells are arranged in two cell stacks lying opposite one another.

23. A vehicle comprising an energy storage module according to claim 21.

24. A method for producing an energy storage cell, the method comprising:
arranging a plurality of electrodes of a first polarity and a plurality of electrodes of a second polarity opposite the first polarity in an electrode stack such that each of a plurality of first conductor lugs of the electrodes of the first polarity protrudes out of the electrode stack on a first side of the electrode stack, and each of a plurality of second conductor lugs of the electrodes of the second polarity protrudes out of the electrode stack on a second side of the electrode stack lying opposite the first sides;
establishing a first electrical connection between the first conductor lugs and a housing;
establishing a second electrical connection between the second conductor lugs and a connecting element arranged in a housing wall of the housing that is electrically insulated from the housing and is configured to electrically connect an outer side of the housing and the second conductor lugs; and
sealing the housing.

25. The method according to claim 24, wherein
the first electrical connection is established between the first conductor lugs and a first housing part,
the second electrical connection is established between the second conductor lugs and the connecting element that is arranged in the housing wall of a second housing part that is provided separately from the first housing part, and
the method further comprises assembling the first housing part and the second housing part.

26. The method according to claim 25, wherein the first housing part and the second housing part are joined together after establishing the electrical connections such that at least the first housing part or the second housing part is tilted relative to the electrode stack.

27. The method according to claim 25, wherein the first housing part and the second housing part are joined together such that at least the first housing part and the electrode stack or the second housing part and the electrode stack are moved together relative to a third housing part.

28. The method according to claim 24, wherein the first conductor lugs are pressed at least in sections by a holding element against the first housing part when establishing the first electrical connection to the first housing part.

29. The method according to claim 24, wherein at least one of the first electrical connection of the first conductor lugs to the first housing part or the second electrical connection of the second conductor lugs to at least one of the second housing part or the assembled housing is established or sealed by laser welding.

30. The method according to claim 28, wherein the holding element is guided at least partially through a filling opening or a strain relief element of the assembled housing into an interior of the assembled housing.
